(19) United States
(12) Patent Application Publication
(10) Pub. No.: US 2025/0255277 A1
(43) Pub. Date: Aug. 14, 2025

(54) PET EXCREMENT COLLECTION APPARATUS

(71) Applicant: Jason Lewis, Brockville (CA)

(72) Inventor: Jason Lewis, Brockville (CA)

(21) Appl. No.: 18/439,386

(22) Filed: Feb. 12, 2024

(51) Int. Cl. A01K 23/00

(52) U.S. Cl. CPC A01K 23/005

(57) ABSTRACT

An excrement collection apparatus for collecting excrement from an animal before the excrement reaches the ground and without touching the excrement directly includes a ring which defines an aperture therein. The ring has a size and is configured to support a bag in the aperture via a rim of the bag folded over the ring. A receiver is coupled to and extends away from the ring, and an elongated pole is removably couplable to the receiver.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to excrement collection apparatuses and more particularly pertains to a new excrement collection apparatus for collecting excrement from an animal before the excrement reaches the ground and without touching the excrement directly.

### (2) Description of Related Art Including Information Disclosed Under 37 CFR 1.97 and 1.98

The prior art relates to excrement collection apparatuses and includes various devices for holding a bag near an animal while the animal defecates to catch excrement dropped from the animal into the bag. However, the prior art fails to describe such an apparatus which uses a ring and hooks to secure the bag via a rim and handles of the bag, and which has a receiver adapted to couple to a threaded pole.

### BRIEF SUMMARY OF THE INVENTION

An embodiment of the disclosure meets the needs presented above by generally comprising a ring which defines an aperture therein. The ring has a size and is configured to support a bag in the aperture via a rim of the bag folded over the ring. A receiver is coupled to and extends away from the ring, and an elongated pole is removably couplable to the receiver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an excrement collection apparatus according to an embodiment of the disclosure.

FIG. 2 is a rear exploded perspective view of an embodiment of the disclosure.

FIG. 3 is a top rear perspective detail view of a ring, a receiver, and a pair of hooks of an embodiment of the disclosure.

FIG. 4 is a bottom rear perspective detail view of a ring, a receiver, and a pair of hooks of an embodiment of the disclosure.

FIG. 5 is a detail in-use view of an embodiment of the disclosure with a bag mounted in a ring of the embodiment.

FIG. 6 is an in-use view of an embodiment of the disclosure.

### DETAILED DESCRIPTION OF THE INVENTION

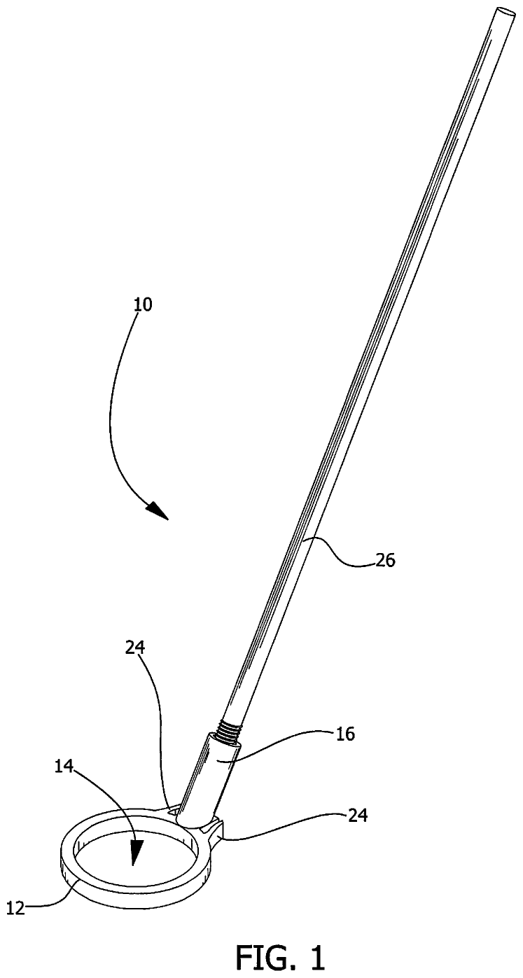

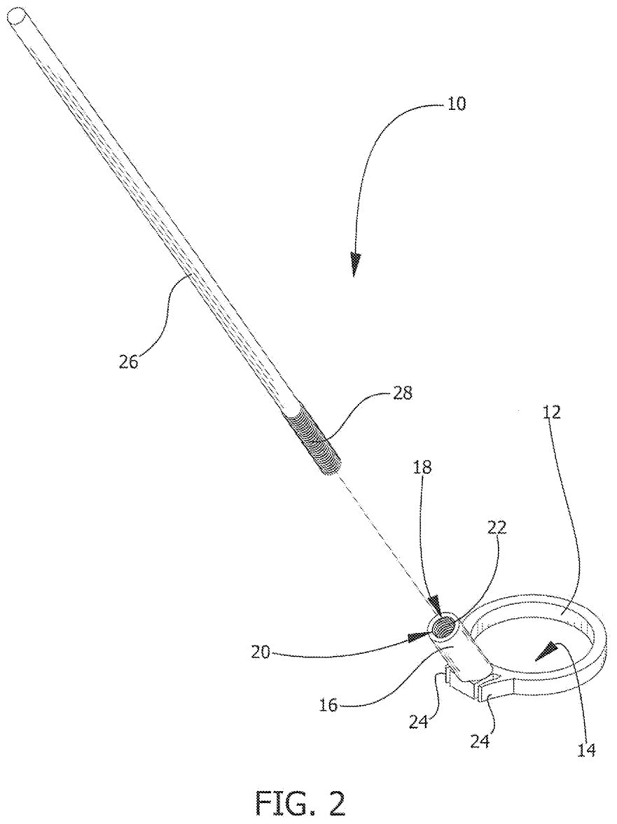

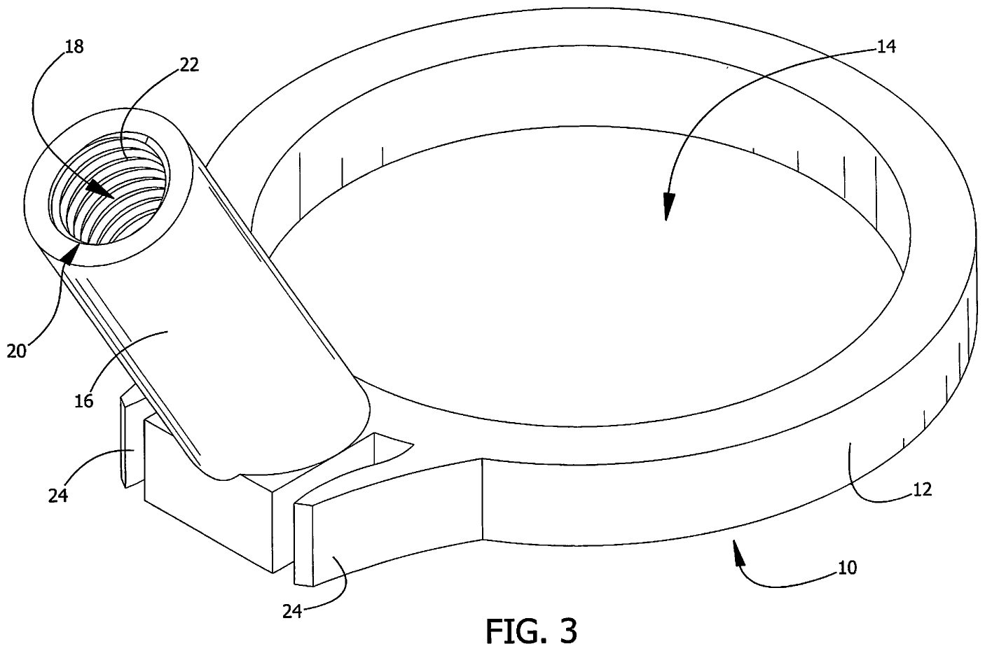

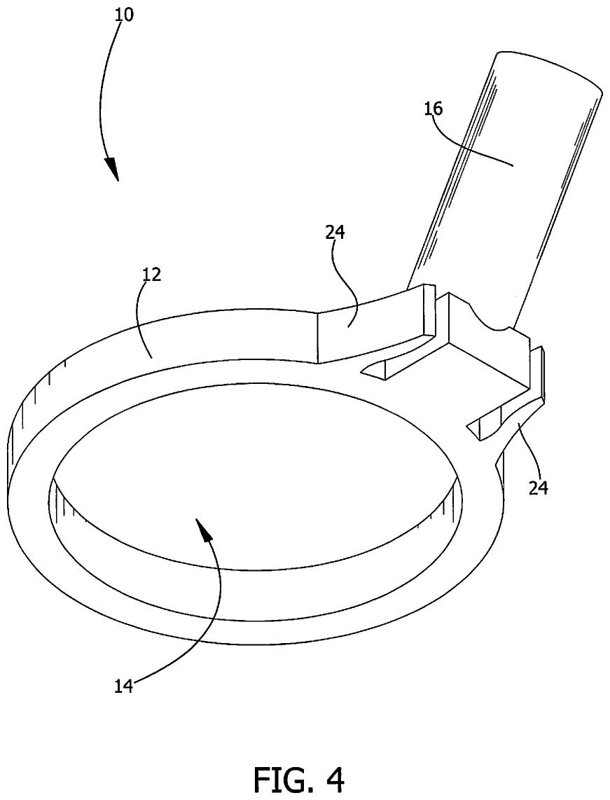

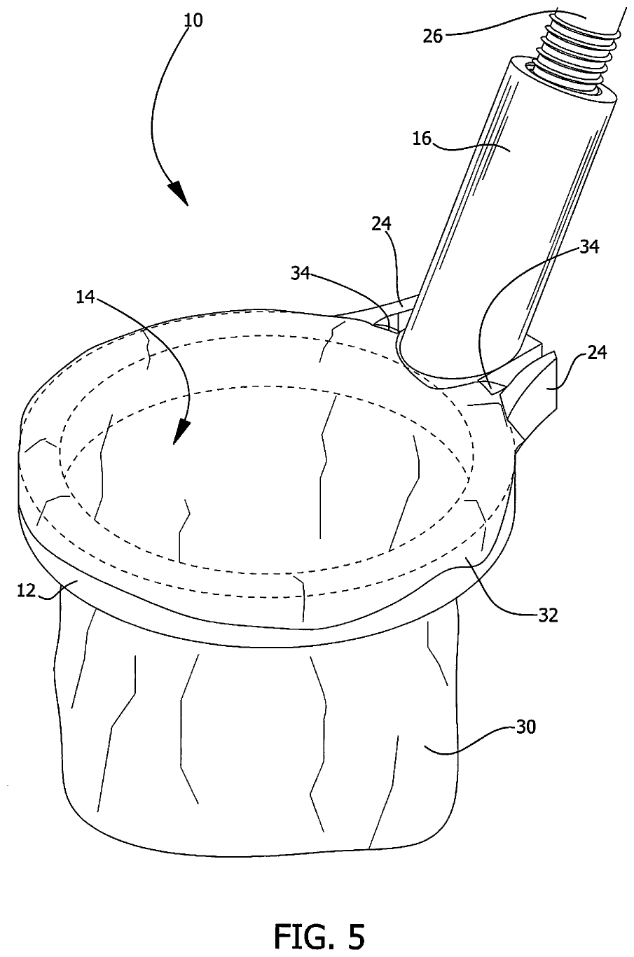

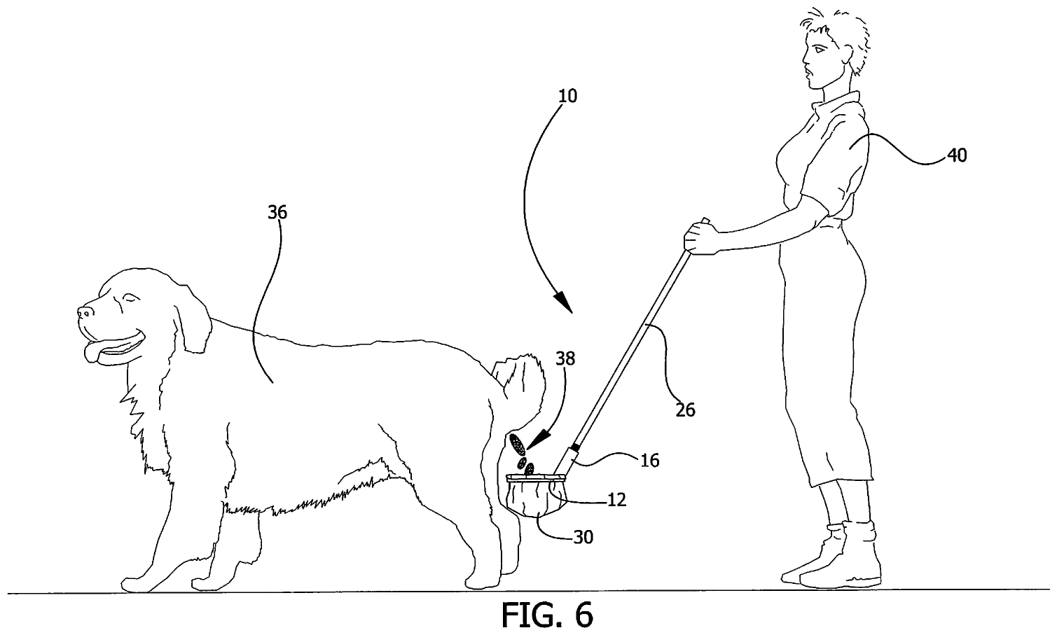

With reference now to the drawings, and in particular to FIGS. 1 through 6 thereof, a new excrement collection apparatus embodying the principles and concepts of an embodiment of the disclosure and generally designated by the reference numeral 10 will be described.

As best illustrated in FIGS. 1 through 6, the excrement collection apparatus 10 generally comprises a ring 12 which defines an aperture 14 therein. The ring 12 has a size and is configured to support a bag 30 in the aperture 14 via a rim 32 of the bag 30 that is folded over the ring 12. The ring 12 has a circular shape so that the rim 32 of the bag 30 is expanded as far as possible for the area of the aperture 14. A receiver 16 is coupled to and extends away from the ring 12. The receiver 16 defines a cavity 18 therein which has an open end 20 positioned distally from the ring 12. The receiver 16 also has internal threads 22 in the cavity 18. The receiver 16 forms an obtuse angle with the ring 12.

A pair of hooks 24 is coupled to the ring 12. The hooks 24 extend outwardly from the ring 12 in a same direction. Each hook 24 is configured to engage an associated handle 34 of a pair of handles 34 of the bag 30 to secure the bag 30 on the ring 12. The hooks 24 are positioned on opposite sides of the receiver 16. The ring 12, the receiver 16, and the hooks 24 are integrally formed with each other and may be made of a plastic or any other suitable material.

An elongated pole 26 is removably couplable to the receiver 16. The elongated pole 26 is receivable into the cavity 18 of the receiver 16 and has external threads 28 which are complementary in shape to the internal threads 22 of the receiver 16. The elongated pole 26 may comprise a broomstick or the like which may also be adapted to removably couple to broom heads, mop heads, and the like. In some embodiments, the elongated pole 26 may be telescopically extendable so that the elongated pole 26 may be collapsed for storage and extended for use.

In use, the elongated pole 26 is coupled to the receiver 16. The handles 34 of the bag 30 are interlocked with the hooks 24 and the rim 32 of the bag 30 is wrapped around the ring 12. The elongated pole 26 is grasped and positioned such that the ring 12 is placed below an animal 36 in the process of defecation such that excrement 38 dropped by the animal 36 may be caught in the bag 30. The receiver 16 directs the elongated pole 26 up and away from the ring 12 so that a user 40 may stand upright behind the animal 36 while using the apparatus 10. The hooks 24 also point away from the elongated pole 26 so that the handles 34 of the bag 30 are positioned away from the animal 36 during 12 use. After collecting the excrement 38 in the bag 30, the user 40 may remove the handles 34 of the bag 30 from the hooks 24 without touching the excrement 38 or touching the portions of the bag 30 containing the excrement 38. The handles 34 may be tied together and the bag 30 and the excrement 38 may be discarded.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An excrement collection apparatus comprising:
a ring defining an aperture therein, the ring having a size and being configured to support a bag in the aperture via a rim of the bag folded over the ring;
a receiver coupled to and extending away from the ring; and
an elongated pole being removably couplable to the receiver.

2. The apparatus of claim 1, wherein:
the receiver defines a cavity therein, the cavity having an open end positioned distally from the ring; and
the elongated pole is receivable into the cavity of the receiver.

3. The apparatus of claim 2, wherein the elongated pole has external threads which are complementary in shape to internal threads of the receiver.

4. The apparatus of claim 2, wherein the receiver forms an obtuse angle with the ring.

5. The apparatus of claim 1, wherein the ring has a circular shape.

6. The apparatus of claim 1, wherein the receiver is integrally formed with the ring.

7. The apparatus of claim 1, further comprising a pair of hooks coupled to the ring, each hook extending outwardly from the ring, the pair of hooks extending in a same direction, each hook being configured to engage an associated handle of a pair of handles of the bag to secure the bag on the ring.

8. The apparatus of claim 7, wherein the hooks are positioned on opposite sides of the receiver.

9. The apparatus of claim 7, wherein the pair of hooks is integrally formed with the ring.

10. An excrement collection apparatus comprising:
a ring defining an aperture therein, the ring having a size and being configured to support a bag in the aperture via a rim of the bag folded over the ring, the ring having a circular shape;
a receiver coupled to and extending away from the ring, the receiver defining a cavity therein, the cavity having an open end positioned distally from the ring, the receiver forming an obtuse angle with the ring, the receiver being integrally formed with the ring;
an elongated pole being removably couplable to the receiver, the elongated pole being receivable into the cavity of the receiver, the elongated pole having external threads which are complementary in shape to internal threads of the receiver; and
a pair of hooks coupled to the ring, each hook extending outwardly from the ring, the pair of hooks extending in a same direction, each hook being configured to engage an associated handle of a pair of handles of the bag to secure the bag on the ring, the pair of hooks being positioned on opposite sides of the receiver, the pair of hooks being integrally formed with the ring.
